(19) United States
(12) Patent Application Publication
(10) Pub. No.: US 2002/0194132 A1
(43) Pub. Date: Dec. 19, 2002

(54) Renting a computing environment on a trusted computing platform

(75) Inventors: Siani Lynne Pearson, Bristol (GB); Alex Chu, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/175,185

(22) Filed: Jun. 18, 2002

(30) Foreign Application Priority Data
Jun. 19, 2001 (GB) 0114884.0

(51) Int. Cl. G06F 17/60

(52) U.S. Cl. 705/52

(57) ABSTRACT

A computing platform rents a computing environment to execute a process supplied from a user device. Integrity of the computing platform is verified using a trusted device which obtains an integrity metric particularly of the host operating system during start up. The computing environment is confirmed as being suitable for the requirements of the process, and then verified ideally again using an integrity metric of the computing environment produced by the trusted device. The user process is then supplied from the user device to the computing environment.

The present invention relates in general to a method for renting a computing environment in a computing platform. Also, the invention relates to a computing platform for renting a computing environment, and to a user device for renting a computing environment on a computing platform.

It is desired to rent a computing environment on a computing platform such as a desktop computer or a server. In one example, a relatively simple user device such as a personal digital assistant is able to store a process which is beyond the capability of that user device to execute. It is therefore desired to rent a computing environment on a more powerful computing platform in order to execute the process. In another example, it is desired to access resources, such as file resources, a printer or network connections, available to a computing platform but not available to a user device, by renting a computing environment on the computing platform.

The computing platform makes a computing environment available to rent to the user device, such as for a particular period of time. Once the rental period is over, control of the computing environment returns to the computing platform and the user device has no further access to the computing environment. Optionally, payment is made for use of the rented computing environment, whether for monetary value or otherwise such as a credits scheme.

It is desired to confirm that the computing environment rented from lender computing platform is safe and secure, such that a process will be executed in the computing environment in a manner expected by the renting user device. For example, it is desired to confirm that the process will not be subverted by unauthorised agents on the lender computing platform such as a virus. Also, it is desired to protect the lender computing platform from unwanted effects of the user process, such as the introduction of a virus onto the lender computing platform.

An aim of the present invention is to provide a method for renting a computing environment which is safe for a lender computing platform, or for a renter user device, and ideally for both. Other aims of the present invention are to provide a user device and a computing platform for renting a computing environment in a manner which is safe for the user device and for the computing platform.

According to a first aspect of the present invention there is provided a method for renting a computing environment in a computing platform, comprising the steps of: (a) verifying integrity of the computing platform; (b) confirming that a suitable computing environment is available for rent from the computing platform; (c) verifying integrity of the computing environment; and (d) supplying a user process for execution within the computing environment.

Preferably, the step (a) comprises communicating with a trusted device of the computing platform to establish that the computing platform is a trusted computing platform. Preferably, the trusted device forms an integrity metric of the computing platform.

Preferably, the step (b) comprises confirming that the computing environment is a compartment. Suitably, the compartment is an application level compartment or preferably an operating system compartment. Preferably, the computing platform provides a host operating system which is a compartmented operating system. Preferably, the step (b) comprises confirming that the computing environment has exclusive access to the compartment.

Preferably, the step (c) comprises communicating with a trusted device of the computing platform to receive an integrity metric of the computing environment. Preferably, the step (c) includes confirming that the trusted device has control over input and/or output of the computing environment.

Preferably, the step (d) comprises executing the user process in the computing environment.

Preferably, the method includes the step of (e) periodically repeating verification of the computing environment.

Preferably, the method includes the step of (f) verifying the user process supplied in the step (d). Preferably, the step (f) comprises verifying that the user process has not been altered since being supplied to the computing environment in step (d). Preferably, the step (f) is repeated periodically.

Preferably, the method includes the step of (g) cleaning the computing environment. Preferably, the method includes the step of (h) verifying that the computing environment has been cleaned.

Suitably, the method is performed by a user device coupled to the computing platform. Suitably, the user device stores the user process which is supplied to the computing platform in step (d).

According to a second aspect of the present invention there is provided a user device for renting a computing environment on a computing platform, comprising: a store for storing a user process; and a processing unit for verifying integrity of the computing platform, confirming that a suitable computing environment is available for rent from the computing platform, verifying integrity of the computing environment, and for supplying a user process from the store for execution in the computing environment.

Preferably, the user device communicates with a trusted device of the computing platform to receive an integrity metric of the computing platform. Preferably, the user device confirms that the computing environment is a compartment. Preferably, the user device communicates with a trusted device of the computing platform to receive an integrity metric of the computing environment. Preferably, the user device periodically repeats verification of the computing environment. Preferably, the user device periodically verifies that the user process has not altered since being supplied to the computing environment.

According to a third aspect of the present invention there is provided a computing platform for renting a computing environment, comprising: a trusted device for verifying integrity of the computing platform and for verifying integrity of the computing environment; and a computing unit for confirming suitability of the computing environment and for receiving a user process from a user device for execution in the computing environment.

Preferably, the trusted device forms an integrity metric of the computing platform and an integrity metric of the computing environment. Preferably, the computing environment is a compartment. Suitably, the computing environment is an application level compartment or preferably an operating system compartment. Preferably, the computing environment has exclusive access to the compartment.

According to a fourth aspect of the present invention there is provided a computing system comprising a user device as described herein coupled to a computing platform as described herein.

For a better understanding of the invention, and to show how embodiments of the same may be carried into effect, reference will now be made, by way of example, to the accompanying diagrammatic drawings in which:

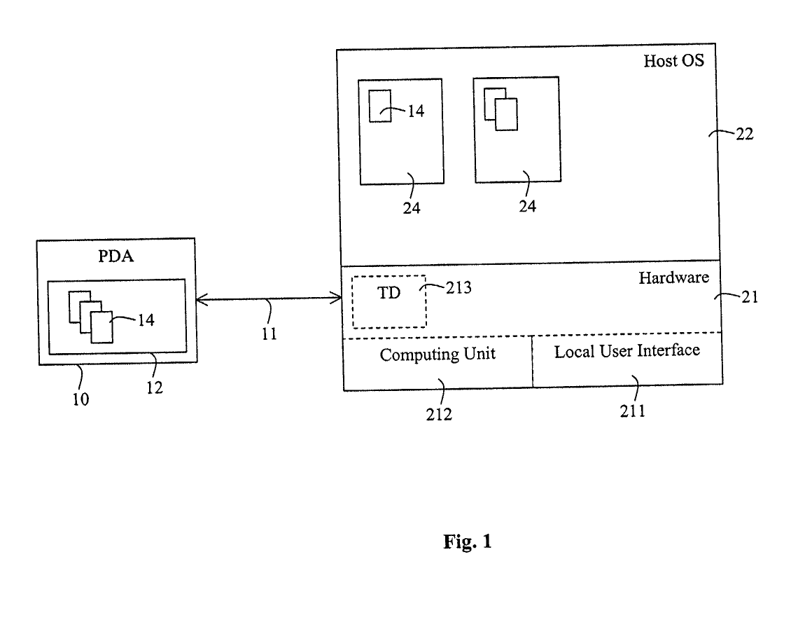

FIG. 1 is a schematic overview of a computing system employed in a preferred embodiment of the present invention; and

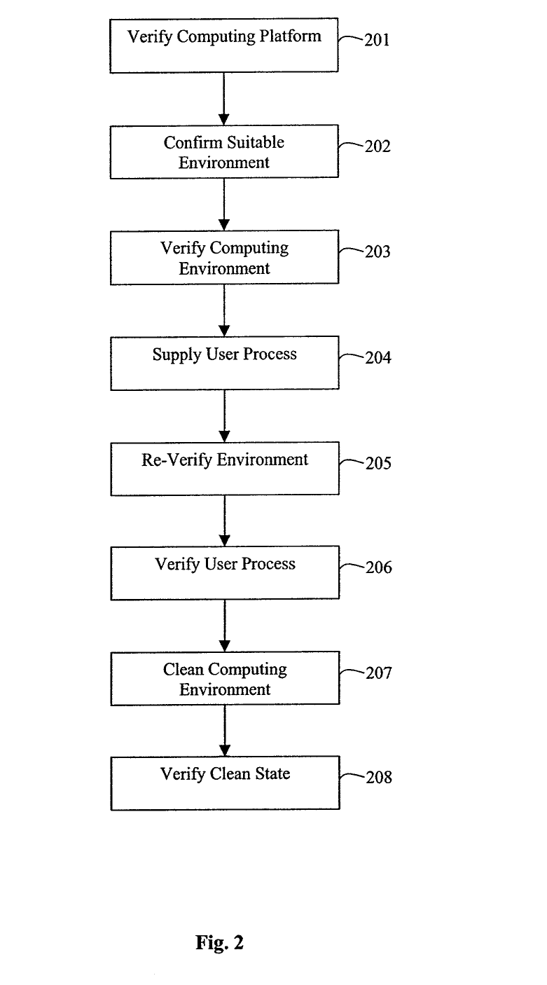

FIG. 2 is a flowchart showing a preferred method for renting a computing environment.

The preferred embodiment of the present invention will be described with reference to an example computing system shown in FIG. 1. The computing system 1 comprises a user device 10 coupled to a computing platform 20. Communication occurs locally such as over a cable connection or infra-red link 11, or occurs remotely across a computer network such as a local intranet or a global internet.

The user device 10 may take any suitable form. Preferably, the user device is readily portable and is sized to be carried by a user. However, reduced size tends to restrict processing power and access to available resources. In one preferred embodiment, the user device 10 is a personal digital assistant (PDA), but other embodiments include a cellular telephone, a laptop computer or a palmtop computer.

In one preferred example, it is desired to use the relatively simple user device 10 to store processes which can be executed on a more powerful computing platform such as a desktop PC or a server. As a practical example, the process performs extensive calculations, or uses graphic intensive resources not available on the user device. In another example it is desired to utilise resources such as a printer or network connections only available on the computing platform.

The user device 10 comprises a store 12 such as an internal memory chip, a removable memory card, or a hard disk. The store 12 stores one or more user processes 14, which can be executed on a computing environment rented from the computing platform 20. In preferred embodiments the or each process 14 is suitably stored as binary code executable by a predetermined type of computing environment, or stored as a higher level generic representation such as Java™ bytecode. Java is a trade mark of Sun Microsystems, Inc.

Referring to FIG. 1, the computing platform 20 comprises hardware 21 operating under the control of a host operating system 22. The hardware 21 suitably includes standard hardware components such as a keyboard, mouse and visual display unit which provide a physical interface 211 to a user of the computing platform 20. The hardware 21 also comprises a computing unit 212 including a main processor, a main memory, an input/output device, a file storage, and other components which together allow the performance of computing operations, including the execution of processes. Other parts of the computing platform are not shown, such as connections to a local or global network. This is merely one example form of computing platform and many other specific forms of hardware are applicable to the present invention.

In the preferred embodiment the hardware 21 includes a trusted device 213. The trusted device 213 is suitably a physical component such as an application specific integrated circuit (ASIC). Preferably the trusted device is mounted within a tamper-resistant housing. The trusted device 213 is coupled to the computing unit 212, and ideally to the local user interface unit 211. The trusted device 213 is preferably mounted on a motherboard of the computing unit 212. The trusted device 213 functions to bind the identity of the computing platform 20 to reliably measured data that provides an integrity metric of the platform.

Preferably, the trusted device 213 performs a secure boot process when the computing platform 20 is reset to ensure that the operating system 22 of the platform 20 is running properly and in a secure manner. During the secure boot process, the trusted device 213 acquires the integrity metric of the computing platform 20 by examining operation of the computing unit 212 and the local user interface unit 211. The integrity metric is then available for a user to determine whether to trust the computing platform to operate is a predicted manner. In particular, a trusted computing platform is expected not to be subject to subversion such as by a virus or by unauthorised access.

WO 00/48063 (Hewlett-Packard) discloses an example computing platform suitable for use in preferred embodiments of the present invention. In this example the trusted device 213 acquires a hash of a BIOS memory of the computing unit 212 after reset. The trusted device 213 receives memory read signals from the main processor and returns instructions for the main processor to form the hash. The hash is stored in the trusted device 213, which then returns an instruction that calls the BIOS program and a boot procedure continues as normal.

The integrity metric optionally comprises several individual integrity metrics each measuring a specific characteristic or component of the computing platform. The individual integrity metrics can be supplied separately or together. Preferably, the individual integrity metrics are combined into one integrity metric available to a user, such as by providing a digest of the individual integrity metrics.

Preferably, the trusted device 213 controls the local user interface 211 such that a local user can trust the display of data provided on a visual display unit. WO 00/73913 (Hewlett-Packard) discloses an example system for providing a trustworthy user interface by locating a driver for the visual display unit within the trusted device 213.

The hardware 21 may also comprise a trusted user interface for performing secure communication with the user device 10 or with a related component such as a smart card 12 held by the user. The trusted user interface allows the user to perform trusted communications with the trusted device 213 in order to verify the integrity of the computing platform 20. The use of a smart card or other token for trusted local user interaction is described in more detail in WO 00/54125 (Hewlett-Packard) and WO 00/54126 (Hewlett-Packard).

The computing platform 20 provides a computing environment 24 which gives access to resources of the computing platform, such as processor time, memory area, and filespace. The computing environment 24 is available for rent to a user device 10. Preferably, a plurality of discrete computing environments 24 are provided, at least one of which is allocated as being available for rent to a user device.

Preferably, the trusted device 213 forms an integrity metric of the computing environment 24 periodically during operation. For example, the computing platform 20 performs data event logging as described in WO 00/73880 (Hewlett-Packard). Also, the computing platform 20 may periodically produce a digest by applying a hash function to data files stored on the computing platform, as described in WO 00/73904 (Hewlett-Packard). Therefore, the user device 10 can confirm the integrity of the computing environment 24 by communicating with the trusted device 213.

Suitably, the computing environment 24 runs as a compartment. The actions or privileges within a compartment are constrained, particularly to restrict the ability of a process to execute methods and operations which have effect outside the compartment 24, such as methods that request network access or access to files outside of the compartment. Also, operation of the process within the compartment is performed with a high level of isolation from interference and prying by outside influences.

Compartments can be formed either as application level compartments, or as operating system level compartments.

One example form of an application level compartment is a Java sandbox, which provides finely grained control of platform resources available to the process. This form of compartment is vulnerable to errors in the application code which enforces the compartment. However well written, errors in application code are always possible and can be exploited by an unscrupulous attacker.

Preferably, the compartment is an operating system compartment controlled by a kernel of the host operating system 22. This is also referred to as a compartmented operating system or a trusted operating system.

Compartmented operating systems have been available for several years in a form designed for handling and processing classified (military) information, using a containment mechanism enforced by a kernel of the operating system with mandatory access controls to resources of the computing platform such as files, processes and network connections. The operating system attaches labels to the resources and enforces a policy which governs the allowed interaction between these resources based on their label values. Most compartmented operating systems apply a policy based on the Bell-LaPadula model discussed in the paper “Applying Military Grade Security to the Internet” by C I Dalton and J F Griffin published in Computer Networks and ISDN Systems 29 (1997) 1799-1808.

The preferred embodiment of the present invention adopts a simple and convenient form of operating system compartment. Each resource of the computing platform which it is desired to protect is given a label indicating the compartment to which that resource belongs. Mandatory access controls are performed by the kernel of the host operating system to ensure that resources from one compartment cannot interfere with resources from another compartment. Access controls can follow relatively simple rules, such as requiring an exact match of the label.

Examples of resources include data structures describing individual processes, shared memory segments, semaphores, message queues, sockets, network packets, network interfaces and routing table entries.

Communication between compartments is provided using narrow kernel level controlled interfaces to a transport mechanism such as TCP/UDP. Access to these communication interfaces is governed by rules specified on a compartment by compartment basis. At appropriate points in the kernel, access control checks are performed such as through the use of hooks to a dynamically loadable security module that consults a table of rules indicating which compartments are allowed to access the resources of another compartment. In the absence of a rule explicitly allowing a cross compartment access to take place, an access attempt is denied by the kernel. The rules enforce mandatory segmentation across individual compartments, except for those compartments that have been explicitly allowed to access another compartment's resources. Communication between a compartment and a network resource is provided in a similar manner. In the absence of an explicit rule, access between a compartment and a network resource is denied.

Suitably, each compartment is allocated an individual section of a file system of the computing platform. For example, the section is a chroot of the main file system. Processes running within a particular compartment only have access to that section of the file system. Advantageously, through kernel controls, the process is restricted to the predetermined section of file system and cannot escape. In particular, access to the root of the file system is denied.

Advantageously, a compartment provides a high level of containment, whilst reducing implementation costs and changes required in order to implement an existing application or process within the compartment.

FIG. 2 shows a preferred method for renting a computing environment on the computer platform 20 to perform a user process supplied from the user device 10.

Firstly, it is desired to establish trust in the computing platform. In step 201 the integrity of the computing platform 20 is verified. Suitably, the user device 10 communicates with the trusted device 213. The trusted device 213 supplies information including the identity of the computing platform 20 and the integrity metric. The integrity metric can cover all or selected parts of the computing platform, and may comprise individual integrity metrics sent separately or combined into a single integrity metric. The integrity metric is compared against a certificate issued by a trusted party that is prepared to vouch for the integrity of the computing platform. In practical embodiments each separate integrity metric is compared against a corresponding certificate representing a corresponding separate stored integrity metric. A challenge and response may occur, such as the user device 10 sending a random number sequence to the computing platform and receiving the random number in return in an encoded format. If the verification is successful, the computing platform is considered a trusted computing platform. The user trusts the computing platform because the user trusts the trusted party. The trusted party trusts the computing platform because the trusted party has previously validated the identity and determined the proper integrity metric of the platform. More detailed background information concerning an example method for verifying the computing platform 20 is given in WO 00/48063 (Hewlett-Packard).

Preferably, step 201 includes the step of performing mutual authentication of the user device 10 and the computing platform 20, such that the computing platform 20 gains a measure of trust in the user device 10. However, where the computing environment offered for rent is a compartment, risks to the computing platform from an unknown or untrustworthy user device are relatively low.

In step 202, the trusted computing platform confirms that a suitable computing environment 24 exists for execution of the user process. Any suitable characteristic of the computing environment 24 can be confirmed. For example, the user device 10 confirms that the computing platform 20 is to provide a computing environment 24 in the form of a compartment, with an operating environment suitable for the process such as with a correct operating system. In some practical embodiments it is desired that the user process interacts with other processes supplied by the computing platform in the compartment 24 or in other compartments, and confirming suitability of the computing environment includes confirming that these other processes are present or that access is given to these other processes through, for example, inter process communication (IPC) channels.

Preferably, the step 202 includes negotiating payment for the offered computing environment 24. Any suitable payment model is employed, and a wide variety of examples will be apparent to the skilled person. In one simple example, a fixed amount is charged for each rental, or an amount charged per unit of an expendable quantity such as elapsed rental time, or processor time, or file storage area or any other suitable characteristic. Payments are made for a monetary value, or a non-monetary value such as a credit token. Preferably, the user device supplies payment details, and the computing platform arranges deduction of the agreed amount. For example, the user device supplies the number of a credit account with the computing platform and the computing platform deducts a predetermined number of credits. Preferably, where the user device includes a token such as a smart card, credits are stored on the smart card and deducted by agreement with the computing platform.

In step 203, the user device 10 confirms that the offered computing environment is secure. For example, the user device 10 requires that the compartment 24 operates within a trusted space controlled by the trusted device 213, or that the trusted device 213 has control over input and output of the compartment 24. Preferably, communication interfaces to the rented compartment 24 do not allow the remainder of the computing platform 20 to access information about processes within the compartment or about communications with the compartment, such that the rented computing environment is private from the remainder of the computing platform. Optionally, the user device provides a specification of the service to be performed on the computing platform including establishing a specified level of trust for a process, and the computing platform agrees to provide a log of the performance of the process performed according to the specified level of trust. In one preferred embodiment the computing platform 20 demonstrates the integrity of the compartment 24 as the computing environment offered for rent in accordance with the method described in a co-pending application entitled “Demonstrating integrity of a compartment of a compartmented operating system” (Hewlett-Packard) filed on even date with the present application.

The user device 10 as the renter is now reasonably confident that the computing environment 24 offered by the lender computing platform 20 is trusted. In step 204, the user device 10 supplies a process 14 for execution in the computing environment 24 provided by the computing platform 20.

Optionally, in step 205 verification of the computing environment 24 is repeated periodically to confirm that the computing environment is still secure. Step 205 can be repeated before, during or after the process is executed in step 204.

Optionally, in step 206 the process is verified. For example, the user device 10 confirms that the process 14 has not been altered since being supplied in step 204. Step 206 is optionally repeated periodically.

Optionally, in step 207 the computing environment is cleaned. Preferably, the renting user device 10 initiates a cleaning operation of the computing environment 24 after the supplied process 14 has been executed. Preferably, the user device 10 and/or the computing platform 20 performs a scrubbing operation to remove data associated with the user process 14 from the rented computing environment 24, such that the computing environment is left in a clean state. The scrubbing operation preferably removes at least some specified data and preferably all data associated with execution of the user process 14. Preferably, the computing environment 24 in the clean state can be offered again for rent to a new user. Alternatively, the computing environment is closed such as by the host operating system closing the relevant compartment 24, and a new computing environment is built for each renting session.

Optionally, in step 208, verification of the cleaning operation is provided. Preferably, the user device 10 confirms that the computing environment 24 has been cleaned. For example, the computing platform 20, and preferably the trusted device 213, supplies information concerning the current status of the computing environment 24 showing that no data remains in the computing environment 24 relevant to execution of the user process 14.

A method, a computing platform and a user device have each been described for renting a computing platform in a manner which is safe for the lender computing platform and for the renter using device. Advantageously, the process is performed in the rented computed environment with a high level of trust for the renting user device 10. Also, a compartment provides a safe computing environment for the lender computing platform 20.

1. A method for renting a computing environment in a computing platform, comprising the steps of:
(a) verifying integrity of the computing platform;
(b) confirming that a suitable computing environment is available for rent from the computing platform;
(c) verifying integrity of the computing environment; and
(d) supplying a user process for execution within the computing environment.

2. The method of claim 1, wherein the step (a) comprises communicating with a trusted device of the computing platform to establish that the computing platform is a trusted computing platform.

3. The method of claim 2, wherein the trusted device forms an integrity metric of the computing platform.

4. The method of claim 1, wherein the step (b) comprises confirming that the computing environment is a compartment.

5. The method of claim 4, wherein the compartment is an application level compartment.

6. The method of claim 4, wherein the compartment is an operating system compartment.

7. The method of claim 4, wherein the step (b) comprises confirming that the computing environment has exclusive access to the compartment.

8. The method of claim 1, wherein the step (c) comprises communicating with a trusted device of the computing platform to receive an integrity metric of the computing environment.

9. The method of claim 8, wherein the step (c) includes confirming that the trusted device has control over input and/or output of the computing environment.

10. The method of claim 1, wherein the step (d) comprises executing the user process in the computing environment.

11. The method of claim 1, comprising the step (e) of periodically repeating verification of the computing environment.

12. The method of claim 1, comprising the step (f) of verifying the user process supplied in the step (d).

13. The method of claim 12, wherein the step (f) comprises verifying that the user process has not been altered since being supplied to the computing environment in step (d).

14. The method of claim 12, wherein the step (f) is repeated periodically.

15. The method of claim 1, comprising the step (g) of cleaning the computing environment.

16. The method of claim 15, comprising the step of (h) verifying that the computing environment has been cleaned.

17. The method of claim 1, wherein the method is performed by a user device coupled to the computing platform.

18. A user device for renting a computing environment on a computing platform, comprising:
a store for storing a user process; and
a processing unit for verifying integrity of the computing platform, confirming that a suitable computing environment is available for rent from the computing platform, verifying integrity of the computing environment, and for supplying a user process from the store for execution in the computing environment.

19. The user device of claim 18, wherein the user device communicates with a trusted device of the computing platform to receive an integrity metric of the computing platform.

20. The user device of claim 18, wherein the user device confirms that the computing environment is a compartment.

21. The user device of claim 18, wherein the user device communicates with a trusted device of the computing platform to receive an integrity metric of the computing environment.

22. The user device of claim 18, wherein the user device periodically repeats verification of the computing environment.

23. The user device of claim 18, wherein the user device periodically verifies that the user process has not altered since being supplied to the computing environment.

24. A computing platform for renting a computing environment, comprising:
a trusted device for verifying integrity of the computing platform and for verifying integrity of the computing environment; and
a computing unit for confirming suitability of the computing environment and for receiving a user process from a user device for execution in the computing environment.

25. The computing platform of claim 24, wherein the trusted device forms an integrity metric of the computing platform and an integrity metric of the computing environment.

26. The computing platform of claim 24, wherein the computing environment is a compartment.

27. The computing platform of claim 26, wherein the computing environment is an application level compartment.

28. The computing environment of claim 26, wherein the computing environment is an operating system compartment.

29. The computing platform of claim 26, wherein the computing environment has exclusive access to the compartment.

30. A computer system comprising:
a user device for renting a computing environment on a computing platform, the user device having a store for storing a user process, and a processing unit for verifying integrity of the computing platform, confirming that a suitable computing environment is available for rent from the computing platform, verifying integrity of the computing environment, and for supplying a user process from the store for execution in the computing environment; and
a computing platform for renting a computing environment, the computing platform having a trusted device for verifying integrity of the computing platform and for verifying integrity of the computing environment, and a computing unit for confirming suitability of the computing environment and for receiving a user process from a user device for execution in the computing environment.
